(19) United States
(12) Patent Application Publication
(10) Pub. No.: US 2011/0246169 A1
(43) Pub. Date: Oct. 6, 2011

(54) SYSTEM AND METHOD FOR SUPPORTING DESIGNING OF SEMICONDUCTOR DEVICE

(75) Inventor: Hironori SAKAMOTO, Kanagawa (JP)

(73) Assignee: RENESAS ELECTRONICS CORPORATION

(21) Appl. No.: 13/075,733

(22) Filed: Mar. 30, 2011

(30) Foreign Application Priority Data
Mar. 31, 2010 (JP) 2010-081643

(51) Int. Cl. G06F 17/50

(52) U.S. Cl. 703/14

(57) ABSTRACT

A semiconductor circuit designing supporting system, includes: a storage unit in which two models of a first model and a second model are stored as device models a semiconductor device; and an operation unit. The operating unit includes: a characteristic variation calculating section configured to calculate a variation of a device characteristic when process parameters are varied by using the first model; and an analyzing section configured to normalize based on the variation, an error between a device characteristic calculated by using the second model and actual measurement data and to analyze the second model by using the normalized error.

### CROSS REFERENCE

This patent application claims a priority on convention based on Japanese Patent Application No. 2010-81643 filed on Mar. 31, 2010. The disclosure thereof is incorporated herein by reference.

### TECHNICAL FIELD

The present invention relates to a designing supporting method for a semiconductor device, and more particularly, to a system and method for evaluating model parameters for a semiconductor device, and a system and method for extracting the model parameters.

When a semiconductor circuit is analyzed or designed, an analysis equation (device model: hereinafter, to be referred to as a model) for calculating electrical characteristics (a current-voltage characteristic and a capacitance-voltage characteristic) of a semiconductor device is used. In order to perform highly accurate circuit simulation, a model is required that can simulate the electrical characteristics of the device with high accuracy.

When the model is generated, the model parameters are extracted such that an error between actual measurement data of a device characteristic and simulation data of the device characteristic by using a model is minimized. At this time, in order to generate an optimum model for circuit design (extract the model parameters), the error should be appropriately evaluated.

As an example, referring to FIGS. 1 to 6, evaluation of an error between measurement data and simulation data in a specific value of drain current Id of a MOSFET (Metal-Oxide-Semiconductor Field-Effect Transistor) will be described. The error evaluation between the simulation data and the measurement data in each of models A, B, and C will be described below. In addition, the models A, B, and C are models to be inspected in fitting processing for extracting the model parameters (model parameter extracting processing).

FIG. 1 is a characteristic graph showing the simulation data and the measurement data in the gate voltage-drain current characteristic of the MOSFET. FIG. 2 is a characteristic diagram showing the simulation data and the measurement data in the gate voltage-drain current characteristic of the MOSFET as a semilog plot. Referring to FIGS. 1 and 2, in a case of an off-condition that the gate voltage Vg is 0V, the drain current Id per unit gate width exhibits a very small value of 10⁻⁹ to 10⁻¹² μA/μm. On the other hand, as the gate voltage Vg is increased, the drain current Id increases exponentially, and when the gate voltage Vg exceeds a threshold voltage Vth, the drain current Id increases linearly or quadratically. In a case of an on-condition where the gate voltage Vg is equal to a power supply voltage, the drain current Id takes a value of a few hundreds μA/μm.

As shown in FIGS. 1 and 2, the simulation data of the model A have a large error from the measurement data in an off-condition region where the gate voltage Vg is lower than the threshold voltage Vth (Vg<Vth). On the other hand, the simulation data of the model B have a large error from the measurement data in an on-condition region where a gate voltage Vg is higher than a threshold voltage Vth (Vg>Vth). Further, the simulation data of the model B have a large error from the measurement data near the threshold voltage Vth.

As described, the gate voltage Vg at which the large error from the measurement data appear are different from each other between the models, and therefore a different model is detected as a model having a smaller error, depending on an error evaluating method.

As the error evaluating method, there is an absolute error error(i) given by the following equation (1) or a relative error error(i) given by the following equation (2), when the measurement data of the drain current is denoted by I_{d,meas}(i) and a simulation data by using the model is denoted by I_{d,sim}(i). It should be noted that i represents each bias condition exemplified by the gate voltage Vg.

$$\begin{matrix}error ( i ) = {I}_{d , sim} ( i ) - {I}_{d , meas} ( i ) & ( 1 ) \\ error ( i ) = 100 \% \times ( \frac{{I}_{d , sim} ( i )}{{I}_{d , meas} ( i )} - 1 ) & ( 2 ) \\ error ( i ) = log ( {I}_{d , sim} ( i ) ) - log ( {I}_{d , meas} ( i ) ) & ( 3 )\end{matrix}$$

FIG. 3 is a diagram illustrating the absolute error error(i) between the simulation data and the measurement data in the gate voltage-drain current characteristic of the MOSFET. As described above, the drain current Id is very small at the gate voltage Vg around 0V; exponentially increases as the gate voltage Vg is increased; and linearly or quadratically increases in the on-condition. For this reason, the absolute error error(i) exhibits a small value at the gate voltage Vg in the off-condition region and around 0V, and then as the gate voltage Vg is increased, exhibit a large value at the gate voltage Vg in the on-condition region. Accordingly, in a case of performing the error evaluation based on the absolute error error(i), the error at the gate voltage Vg in the off-condition region where the drain current Id is small is evaluated to be small, but the error at the gate voltage Vg in the on-condition region is mainly evaluated. In the example of FIG. 3, the model A is evaluated as a model having small error values, and the model B is evaluated as a model having large error values.

FIG. 4 is a diagram illustrating the relative error error(i) between the simulation data and the measurement data in the gate voltage-drain current characteristic of the MOSFET. The drain current Id exhibits a very small value at the gate voltage Vg of around 0V, and therefore the relative error error(i) around 0V exhibit a large value. On the other hand, in the on-condition region, the drain current Id increases, and therefore the relative error error(i) exhibits a small value. Accordingly, in a case of performing error evaluation based on the relative error error(i), the error at the gate voltage Vg in the on-condition region is evaluated to be small, but the error at the gate voltage Vg in the off-condition is mainly evaluated. In the example of FIG. 4, the model B is evaluated as a model having small error values, and the model A is evaluated as a model having large error values.

As described, the electrical characteristics are different, depending on the bias condition, and therefore an under-evaluated region appears depending on an error. For example, in a case of performing the evaluation based on the absolute error, the off-condition region is under-evaluated, and therefore the model A having large relative error values in the off-condition is selected as an appropriate model. On the other hand, in a case of performing the evaluation based on the relative error, the on-condition region is under-evaluated, and therefore the model B having the large absolute error values in the on-condition is selected as an appropriate model.

Such a problem occurs in a case of evaluating the absolute error of a log value (log error) of the drain current Id, which is given by the above equation (3) and illustrated in FIG. 5.

On the other hand, when a model is generated, model parameters obtained when a mean value of errors total_error given by the following equation (4), or a square mean value of errors total_error given by the following equation (5) is minimized are extracted as optimum model parameters. In the following equations, N represents the number of bias conditions i to be analyzed:

$$\begin{matrix}total\_error = \frac{1}{N} {\sum }_{i} error ( i ) & ( 4 ) \\ total\_error = \sqrt{\frac{1}{N} {\sum }_{i} {error ( i )}^{2}} ( Here , N = {\sum }_{i} 1 ) & ( 5 )\end{matrix}$$

However, even in a case of using any of the above-described error evaluating methods, the error cannot be appropriately evaluated in some bias condition, and therefore accuracy of a model may be reduced.

A technique to solve such a problem will be described in JP 2005-38216A. In Patent Literature 1, a calculation method for the error is changed for each bias condition, and thereby a region that is under-evaluated on the basis of difference among evaluating methods is complemented with another evaluating method. Specifically, in the case where a bias condition i is Vg<Vth, errors given by the following equation (6) are evaluated, whereas in the case where a bias condition j is Vg Vth, errors given by the following equation (7) are evaluated. At this time, a mean value of errors used to generate a model is given by the following equation (8) or (9) as a square mean value of the errors in each of the bias conditions i and j. In the following expressions, N represents the number of bias conditions i, j to be analyzed.

$$\begin{matrix}error ( i ) = \frac{log ( {I}_{d , sim} ( i ) ) - log ( {I}_{d , meas} ( i ) )}{max ( log ( {I}_{d , sim} ( i ) ) - min ( log ( {I}_{d , meas} ( i ) )} & ( 6 ) \\ error ( j ) = \frac{log ( {I}_{d , sim} ( j ) ) - log ( {I}_{d , meas} ( j ) )}{max ( log ( {I}_{d , sim} ( j ) ) - min ( log ( {I}_{d , meas} ( j ) )} & ( 7 ) \\ total\_error = \sqrt{\frac{1}{N} ( {\sum }_{i} {error ( i )}^{2} + {\sum }_{j} {error ( j )}^{2} )} & ( 8 ) \\ N = {\sum }_{i} 1 + {\sum }_{j} 1 & ( 9 )\end{matrix}$$

### CITATION LIST

[Patent Literature 1]: JP 2005-38216A
[Non-Patent Literature 1]: M. Miura Mattausch, et al., “Unified complete MOSFET model for analysis of digital and analog circuits”, IEEE Trans. CAD/ICAS, Vol. 15, No. 1, pp. 1-7, 1996. 1
[Non-Patent Literature 2]: H. Sakamoto, et al., “A Discrete Surface Potential Model which Accurately Reflects Channel Doping Profile and its Application to Ultra-Fast Analysis of Random Dopant Fluctuation”, Proc. of SISPAD 2009, pp. 95-98, 2009

### SUMMARY OF THE INVENTION

FIG. 6 is a diagram showing errors between the simulation data of the models A, B, and C and the measurement data, which are evaluated by the method in Patent Literature 1. In the method of Patent Literature 1, the errors are calculated by a different method across the threshold voltage Vth as a border, and therefore exhibit discontinuous values around the threshold voltage Vth. In this case, the error around the threshold value Vth is not appropriately evaluated. For example, as in the model C, even in the model having large relative error values from the measurement data around the threshold voltage Vth, the errors around the threshold value Vth may be under-evaluated.

If model parameters are extracted through such evaluation, model accuracy is reduced at the gate voltage Vg near the threshold voltage Vth.

Also, the square mean value of the errors total_error shown by the above equation (8) uses the error values calculated by the different methods, and therefore, is not strictly a square mean value of the error values, but physically a meaningless value. For example, total_error=0.1 does not necessarily means that model based simulation data have the error of 10% with respect to the measurement data.

For this reason, in a case of using a generated model for circuit design, it is difficult to involve the extraction error of the model parameters, which may lead to under- or over-evaluation of a margin in the circuit design.

In an aspect of the present invention, a semiconductor circuit designing supporting method, is executed by a computer, and is attained by storing two models of a first model and a second model in a storage unit as a device model of a semiconductor device; by calculating a variation of a device characteristic when process parameters are varied, by using the first model; by normalizing an error between device characteristic data calculated by using the second model and actual measurement data, based on the device characteristic variation; and by analyzing the second model by using the normalized error.

In another aspect of the present invention, a semiconductor circuit designing supporting system, includes: a storage unit in which two models of a first model and a second model are stored as device models a semiconductor device; and an operation unit. The operating unit includes: a characteristic variation calculating section configured to calculate a variation of a device characteristic when process parameters are varied by using the first model; and an analyzing section configured to normalize based on the variation, an error between a device characteristic calculated by using the second model and actual measurement data and to analyze the second model by using the normalized error.

Also, a non-transitory computer-readable recording medium storing program code, is executed by a computer, is provided to attain the above semiconductor circuit designing supporting method.

According to the present invention, independently of a bias condition, analysis accuracy for a model can be improved.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 is a diagram showing simulation data and measurement data in gate voltage-drain current characteristic of a MOSFET;

FIG. 2 is a diagram showing the simulation data and the measurement data in the gate voltage-drain current characteristic of the MOSFET;

FIG. 3 is a diagram showing absolute error between the simulation data and the measurement data in the gate voltage-drain current characteristic of the MOSFET;

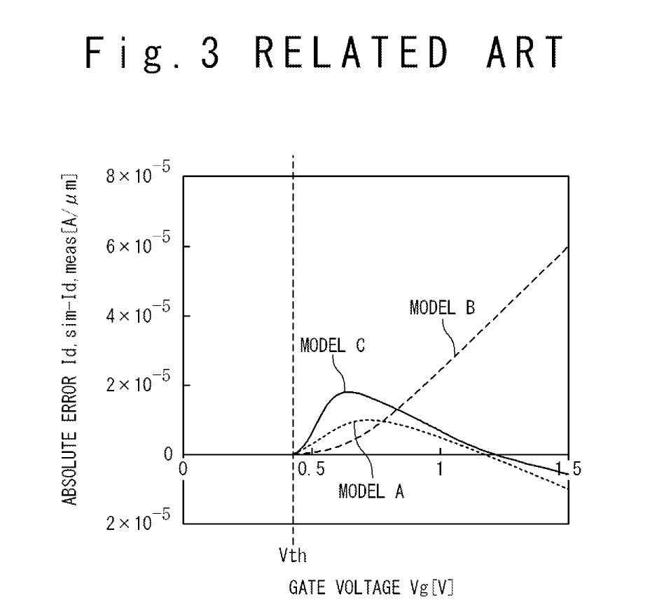

FIG. 4 is a diagram showing relative error between the simulation data and the measurement data in the gate voltage-drain current characteristic of the MOSFET;

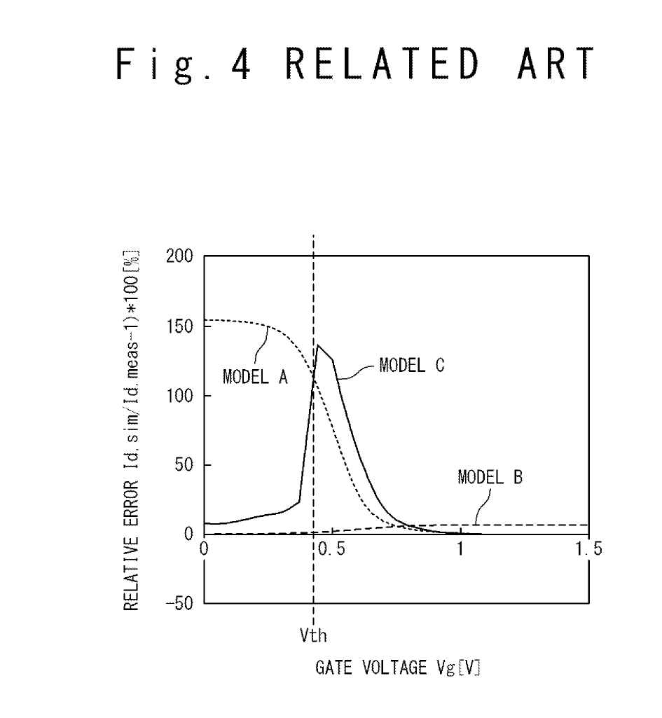

FIG. 5 is a diagram showing log error between the simulation data and the measurement data in the gate voltage-drain current characteristic of the MOSFET;

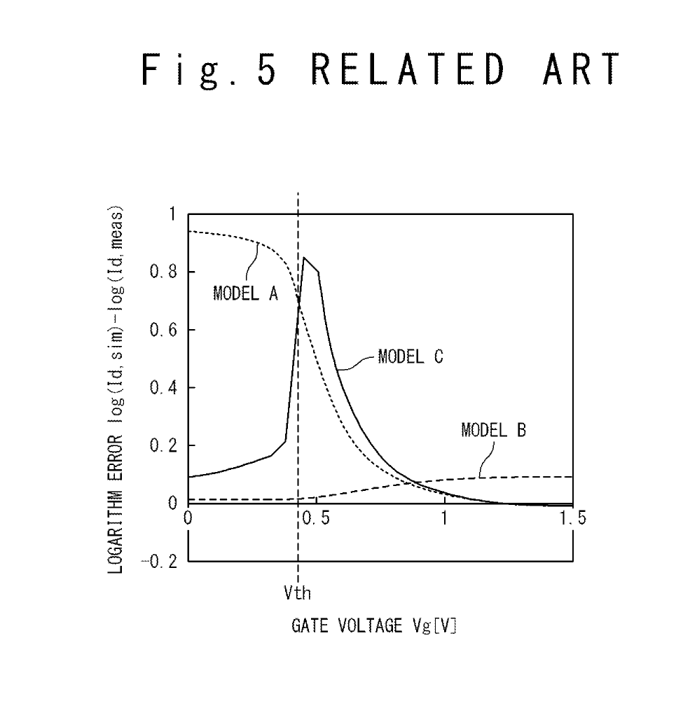

FIG. 6 is a diagram showing error between the measurement data and the simulation data in models A, B, and C, evaluated a convention method;

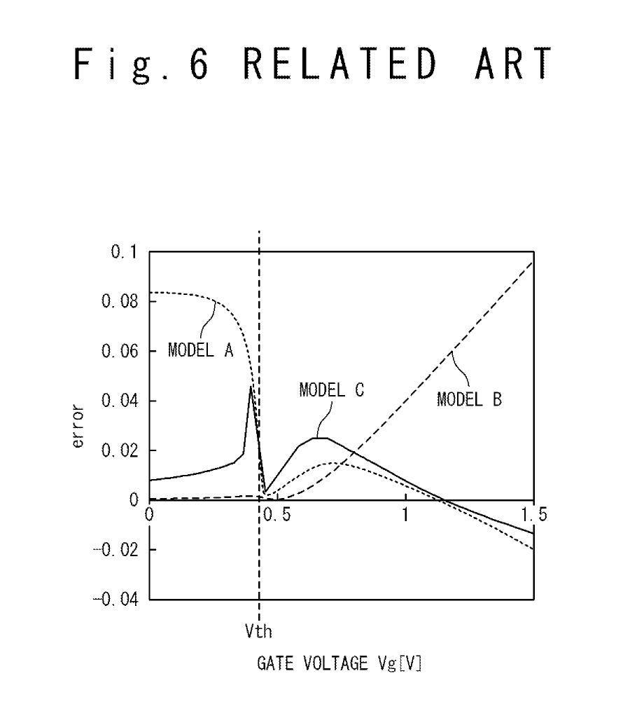

FIG. 7 is a diagram showing a configuration of a semiconductor circuit designing supporting system in a first and second embodiments of the present invention;

FIG. 8 is a functional block diagram of the semiconductor circuit designing supporting system according to the first embodiment of the present invention;

FIG. 9 is a diagram showing a variation simulation result based on a first model associated with the present invention;

FIG. 10 is a diagram showing log error between simulation data and measurement data in gate voltage-drain current characteristic of a MOSFET and a characteristic variation due to a process variation;

FIG. 11 is a diagram showing error evaluated by an evaluation method according to the present invention;

FIG. 12 is a functional block diagram of the semiconductor circuit designing supporting system according to the second embodiment of the present invention;

FIG. 13 is a diagram showing a configuration of the semiconductor circuit designing supporting system according to a third embodiment of the present invention;

FIG. 14 is a functional block diagram of the semiconductor circuit designing supporting system according to the third embodiment of the present invention; and

FIG. 15 is a diagram showing a margin design by using a model extracted by a model extracting method according to the present invention.

### DETAILED DESCRIPTION OF EMBODIMENTS

Hereinafter, a semiconductor device designing supporting system of the present invention will be described in detail with reference to the attached drawings. In the drawings, the same or similar reference numerals are assigned to the same and similar components. As a semiconductor device to be analyzed, a MOSFET is taken as an example to describe a semiconductor circuit designing supporting system and a semiconductor circuit designing support method that perform analysis on a device model of the MOSFET. Also, as analytical content according to the present invention, the model evaluation, the model parameter extraction, and the margin design will be described.

### First Embodiment

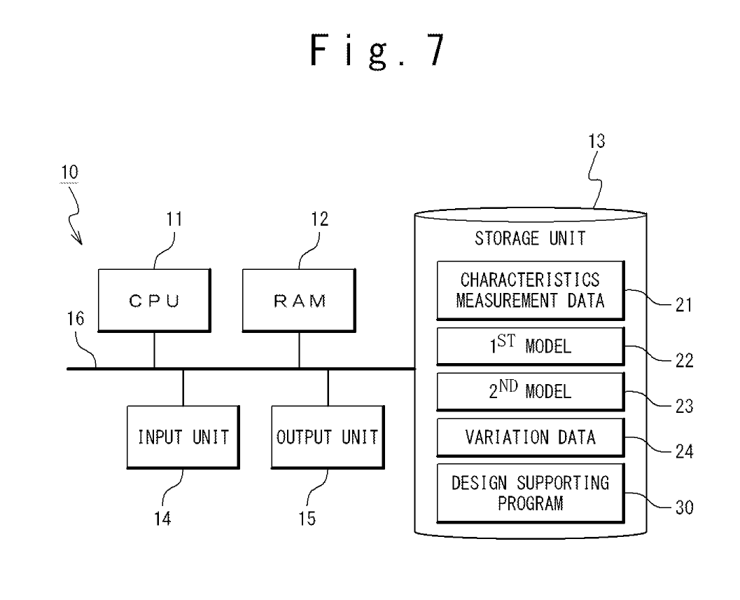

Referring to FIGS. 7 to 11, the semiconductor circuit designing supporting system 10 (hereinafter, to be referred to as a designing supporting system 10) according to a first embodiment of the present invention will be described. In the first embodiment, the system and method that perform evaluation on prepared models will be described.

FIG. 7 is a block diagram showing a configuration of the designing supporting system 10 according to the first embodiment of the present invention. The designing supporting system 10 is provided with a CPU 11, a RAM 12, a storage unit 13, an input unit 14, and an output unit 15 that are mutually connected through a bus 16. The storage unit 13 is an external storage unit such as a hard disk unit and a memory unit. Also, the input unit 14 outputs various types of data to the CPU 11 or storage unit 13 through an operation of a keyboard such as a mouse by a user. The output unit 15 is such as a monitor and a printer, and visibly outputs an evaluation result of the model parameters outputted from the CPU 11 to the user.

The storage unit 13 stores characteristic measurement data 21, a first model 22, a second model 23, variation data 24, and a design supporting program 30. The CPU 11 executes the design supporting program 30 in the storage unit 13 in response to an input from the input unit 14, to evaluate a semiconductor device model. At this time, various types of data and the program are read from the storage unit 13 and are temporarily stored in the RAM 12, and the CPU 11 uses the various types of data in the RAM 12 to perform various types of processing.

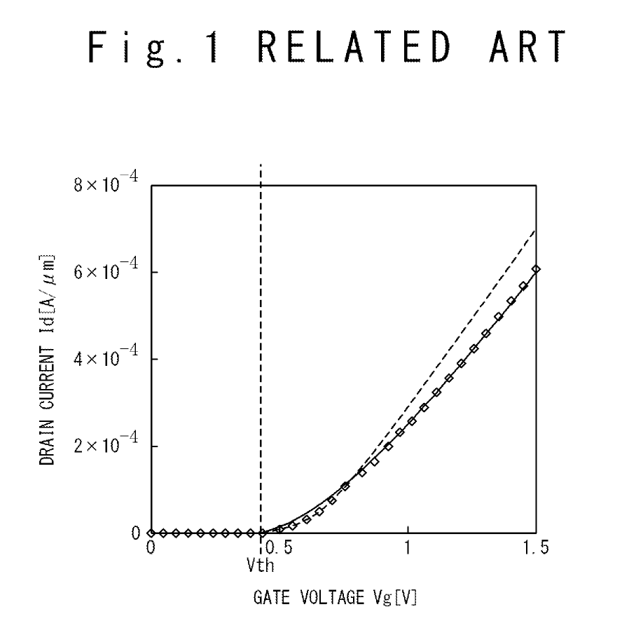

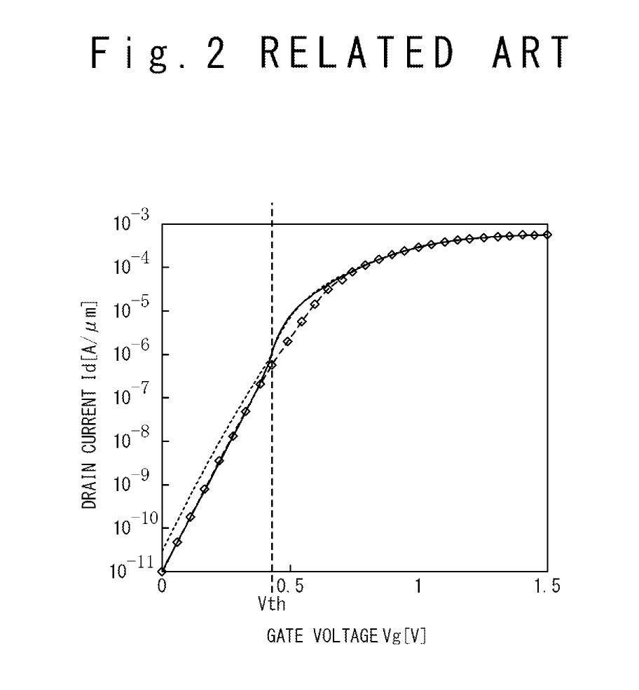

The characteristic measurement data 21 are obtained as a result of measuring electrical characteristics such as current-voltage characteristic and capacitance-voltage characteristic of a real device. For example, as illustrated in FIGS. 1 and 2, measurement data in drain current characteristic of transistors with various sizes are stored as the characteristic measurement data 21.

The first model 22 is preferably a device model (analysis formulae) that prediction accuracy of a variation in characteristic is high with no relation to a device condition, even when the model parameters corresponding to parameters of a semiconductor process vary. The high prediction accuracy of a variation in characteristic means that when the model parameters such as an oxide film thickness, a channel impurity concentration, and a gate width are varied, a simulation-based variation in characteristic and a measured variation coincide with each other within a predetermined range. A model that calculates data different from the measured data cannot be used as the first model 22. For example, preferably, a model proposed in Non-Patent Literature 1 (HiSIM), or a model proposed in Non-Patent Literature 2 is used as the first model 22.

The second model 23 is a device model (analysis equation) that is used to design or analyze a circuit. As the second model 23, a conventional model or a same model as the first model 22 can be used.

The variation data 24 refer to data that define a variation range of process parameters. The process parameters include parameters such as a gate length L, a gate width W, an oxide film thickness Tox, and a channel impurity concentration Nsub of a MOSFET. As the variation data 24, a variation range of a previously measured process (gate length L, gate width W, and oxide film thickness Tox), a variation range of a channel impurity concentration Nsub evaluated from a past variation range of process, a variation range of an impurity concentration Nsub predicted from previously performed TCAD (Technology CAD) simulation, or a theoretically predicted variation range of process parameter are preferably set.

The design supporting program 30 in the first embodiment is executed by the CPU 11 to realize functions of a first model parameter extracting section 31, a characteristic variation calculating section 32, and a characteristic error evaluating section 33 (model analysis section).

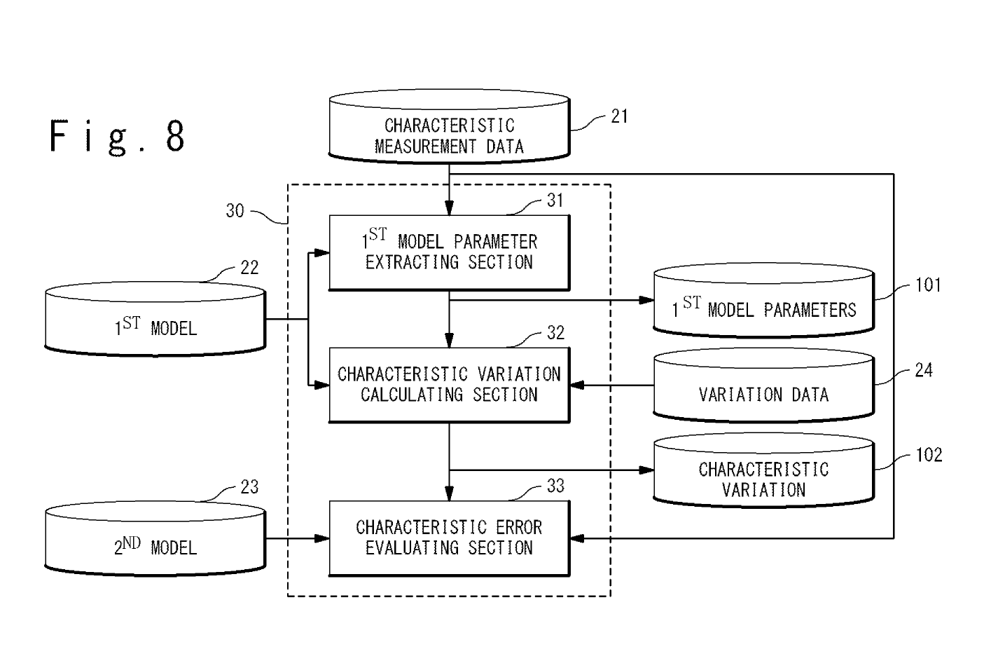

FIG. 8 is a functional block diagram of the semiconductor circuit designing supporting system according to the first embodiment of the present invention. Referring to FIG. 8, the respective functions realized by the design supporting program 30 will be described. In the following description, electrical characteristics to be analyzed and a bias condition will be described as a gate voltage-drain current characteristic and a gate voltage Vg. It should be noted that the bias condition i may be any of a substrate voltage Vb, a drain voltage Vd, a source voltage Vs, and an operation temperature T.

The first model parameter extracting section 31 performs fitting processing between the characteristic measurement data 21 and simulation data of the first model 22 to extract optimum model parameters (hereinafter, to be referred to as the first model parameters 101). In this case, the first model 22 is used, only the main model parameters are varied to extract the first model parameters 101 according to an algorithm exemplified by a least square method, a Newton method, a Marquardt method, or the like. At this time, it is preferable to perform the fitting processing between the measured data and the simulation data with respect to main bias conditions (e.g., a cases where the gate voltage Vg is 0V, threshold voltage Vth, and power supply voltage).

For example, the first model parameter extracting section 31 uses only the main parameters, and performs the fitting processing of device characteristics (such as drain current characteristic) in the three bias conditions of the gate voltage Vg is 0V, the threshold voltage Vth, and the power source voltage to extract the first model parameters 101. It should be noted that the bias conditions to be fitted are not limited to the above three points. However, in order to improve reliability of the first model parameters 101, it is preferable to perform the fitting processing in at least three bias conditions, i.e., the bias condition that the transistor is in an off state, near the threshold voltage of the transistor, and the bias condition that the transistor is in an on state.

Preferably, the main parameters used to extract the first model parameters 101 are, for example, the oxide film thickness Tox, the channel impurity concentration Nsub, and a mobility μ of the MOSFET.

The first model parameters 101 extracted by the first model parameter extracting section 31 include data on a manufacturing condition, dimensions, and an operation condition of a device (e.g., transistor), and other data. For example, the data on the manufacturing conditions of the transistor include data on manufacturing conditions such as an ion implantation condition, and a diffusion condition of a gate electrode, a gate oxide film, and a diffusion layer (source region/drain region). As the data on the manufacturing conditions, a carrier mobility μ, a channel impurity concentration Nsub, and a flat band voltage Vfb are exemplified. Also, as the data on the dimensions (configuration) of the transistor, a gate length L, a gate width W, and an oxide film thickness Tox are exemplified. Further, as the data on the operation condition (bias condition) of the transistor, a substrate voltage Vb, a gate voltage Vg, a drain voltage Vd, a source voltage Vs, and an operation temperature T are exemplifies.

The characteristic variation calculating section 32 uses the first model parameters 101 and the first model to simulate a characteristic variation when the process parameters vary. At this time, the characteristic variation calculating section 32 varies the process parameters in the first model parameters within the variation ranges defined by the variation data 24. The process parameters to be varied are preferably the gate length L, the gate width W, the oxide film thickness Tox, and the channel impurity concentration Nsub.

The characteristic variation calculating section 32 calculates the characteristic variation 102 from differences between device characteristic simulation data using the first model parameters 101 before the variation and simulation data using the first model parameters 101 in which the process parameters are varied by predetermined amounts.

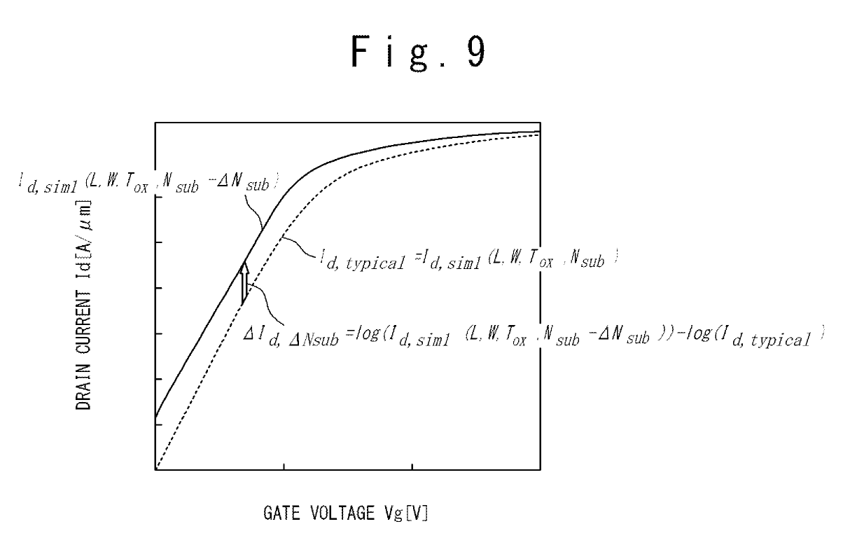

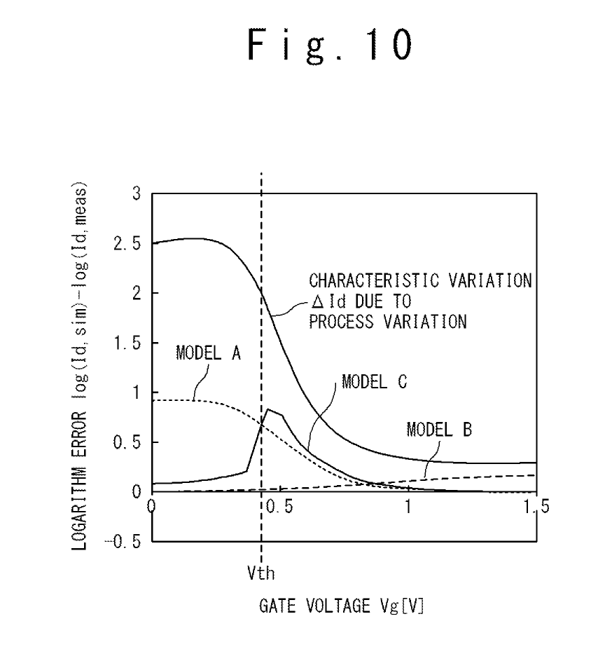

Referring to FIGS. 9 and 10, details of a method of calculating the characteristic variation 102 in the electrical characteristics of the semiconductor device will be described.

First, the characteristic variation calculating section 32 uses the first model parameters 101 such as the gate length L, the gate width W, the oxide film thickness Tox, and the channel impurity concentration Nsub to calculate the first model 22 (sim1) with respect to the bias condition i, and thereby calculates a drain current I_{d,typical}(i) that is given by the following equation (10) and illustrated in FIG. 9:

I_{d,typical}(i)=I_{d,sim1}(L,W,Tₒₛ,N_{sub},i) (10)

Next, the characteristic variation calculating section 32 uses the model parameters obtained by varying each of the gate length L, the gate width W, the oxide film thickness Tox, and the channel impurity concentration Nsub of the first model parameters 101 with respect to the bias condition i to calculate the first model 22 (sim1), and thereby calculates a drain current for each of the varied parameters. At this time, preferably, the characteristic variation calculating section 32 varies each of the process parameters so as to increase the drain current.

In this case, the drain current I_{d,sim1}(L−L, W, Tox, Nsub, i) when the gate length L is varied by L, the drain current I_{d,sim1}(L, W+W, Tox, Nsub, i) when the gate width W is varied by W, the drain current I_{d,sim1}(L, W, Tox−Tox, Nsub, i) when the oxide film thickness Tox is varied by Tox, and the drain current I_{d,sim1}(L, W, Tox, Nsub−Nsub, i) when the channel impurity concentration Nsub is varied by Nsub are calculated. Then, the characteristic variation calculating section 32 calculates a difference between a log value of the drain current for each of the varied parameters and a log value of the drain current I_{d,typical}(i) as the characteristic variation for each of the varied parameters. Results of the calculations are given by the following equations (11) to (14). Also, as an example, the characteristic variation (drain current variation) “I_{d,ΔNsub}” when the channel impurity concentration Nsub is varied by Nsub is illustrated in FIG. 9.

ΔI_{d,ΔL}(i)=log(I_{d,sim1}(L−ΔL,W,Tₒₓ,N_{sub},i))−log(I_{d,typical}(i)) (11)

ΔI_{d,ΔW}(i)=log(I_{d,sim1}(L,W+ΔW,Tₒₓ,N_{sub},i))−log(I_{d,typical}(i)) (12)

ΔI_{d,ΔTox}(i)=log(I_{d,sim1}(L,W,Tₒₓ−ΔTₒₓ,N_{sub},i))−log(I_{d,typical}(i)) (13)

ΔI_{d,ΔNsub}(i)=log(I_{d,sim1}(L,W,Tₒₓ,N_{sub}−ΔN_{sub},i))−log(I_{d,typical}(i)) (14)

The characteristic variation calculating section 32 calculates a root of a square sum of the characteristic variations of the respective varied parameters as the characteristic variation 102 “Id(i)”. A result of the calculation is given by the following equation (15):

$$Δ {I}_{d} ( i ) = \sqrt{Δ {{I}_{d , Δ L} ( i )}^{2} + Δ {{I}_{d , Δ W} ( i )}^{2} + Δ {{I}_{d , Δ Tox} ( i )}^{2} + Δ {{I}_{d , Δ Nsub} ( i )}^{2}} \qquad ( 15 )$$

In the above example, the process parameters to be varied are the gate length L, the gate width W, the oxide film thickness Tox, and the channel impurity concentration Nsub. However, other parameters may be varied. Also, a combination of parameters to be varied can be arbitrarily set. Further, at the time of calculating the characteristic variation 102, the variation may be determined based on any value inputted by a user without using the variation data 24.

The above calculation of the characteristic variation 102 is performed under the device condition For example, as illustrated in FIG. 10, the characteristic variation 102 “Id(i)” is calculated in a predetermined gate voltage Vg within a range between the gate voltage Vg=0V and a power supply voltage 1.5V.

The characteristic error evaluating section 33 evaluates an error between device characteristic calculation data by using the second model 23 and the characteristic measurement data 21, and outputs a result of the evaluation to the output unit 15. At this time, the characteristic error evaluating section 33 normalizes the error based on the characteristic variation 102 to evaluate the error.

Specifically, as shown by the following equation (16), the characteristic error evaluating section 33 calculates as an error error(i) under the bias condition i, data obtained by dividing characteristic calculation data (in this case, a difference between a log value of the drain current I_{d,sim}(i) by using the second model 23 (sim2) and a log value of the characteristic measurement data 21) by the characteristic variation 102 “Id(i)”. It should be noted that the characteristic variation of for every varied parameter, or the error error(i) may be calculated without calculating the logarithm:

$$error ( i ) = 100 \% \times \frac{log ( {I}_{d , sim 2} ( i ) ) - log ( {I}_{d , meas} ( i ) )}{Δ {I}_{d} ( i )} \qquad ( 16 )$$

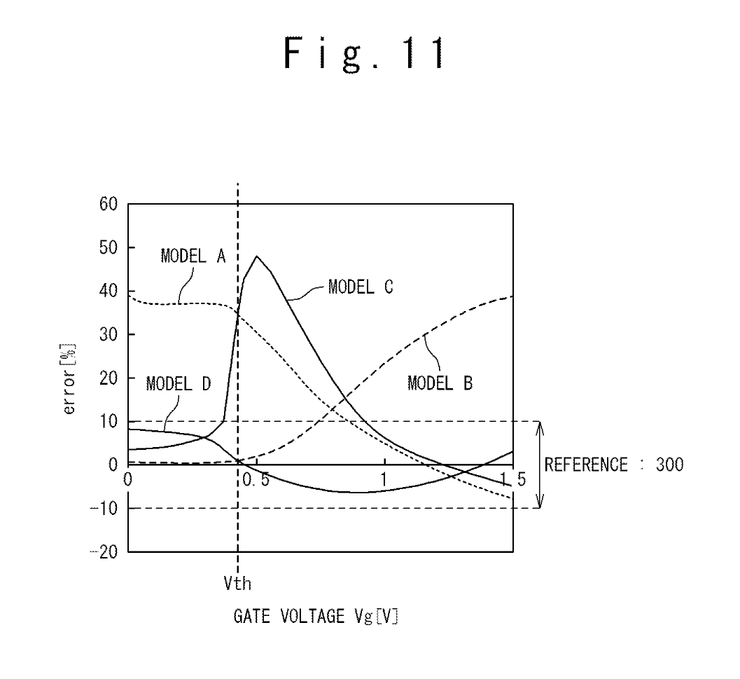

FIG. 11 is a diagram illustrating an example of the error error(i) to be evaluated by the evaluating method according to the present invention. Referring to FIG. 11, the characteristic error evaluating section 33 determines that a model D in which the error error(i) falls within a reference range 300 is an appropriate model that can be used for circuit analysis. Also, models A, B, and C in which the error does not fall within the reference range 300 are determined to be inappropriate models that cannot be used for circuit analysis. The reference range 300 is preferably set for each second model 23 to be evaluated.

Alternatively, the characteristic error evaluating section 33 may use a square mean of error values under the bias condition i as a mean error total_error to evaluate the model. In this case, the mean error total_error is given by the following equations (17) and (18). In the following equations, N represents the number of bias conditions i to be analyzed.

$$\begin{matrix}total\_error = \sqrt{\frac{1}{N} {\sum }_{i} {errir ( i )}^{2}} & ( 17 ) \\ N = {\sum }_{i} i & ( 18 )\end{matrix}$$

In this case, if the mean error total_error is equal to or less than a reference value, the characteristic error evaluating section 33 determines that the second model 23 is an appropriate model that can be used for circuit analysis. On the other hand, if the mean error total_error exceeds the reference value, the second model 23 is determined to be an inappropriate model that cannot be used for circuit analysis. It should be noted that the mean error total_error is not limited to the square mean but may be a mean value.

Also, the characteristic error evaluating section 33 may output as an evaluation result, whether or not the mean error total_error is equal to a value (minimum value of errors) obtained when the second model 23 is fit to the characteristic measurement data 21. In this case, if the mean error total_error indicates the minimum value, the evaluated model parameters of the second model 23 are evaluated to be usable for circuit analysis or circuit design.

As described above, in the designing supporting system 10 according to the present invention, the error between a characteristic simulation result by using the model and the characteristic measurement data is normalized based on the characteristic variation obtained through the simulation by using the first model 22 having high prediction accuracy. The error to be evaluated in the present invention is normalized based on the same reference in a range from the off-condition to the on-condition of a transistor, and therefore the evaluation is not biased depending on the bias condition. Also, the mean error total_error shown by the above equation (17) represents the error value with respect to the characteristic variation due to a process variation. For example, when the mean error total_error is 10%, it means that even under any bias condition i, the error between the simulation result by using the second model 23 and the characteristic measurement data 21 is 10% with respect to the characteristic variation due to the process variation.

Also, the present invention can be used not only for the drain current error evaluation but also for evaluation of a variation in GM (transconductance) or GDS (drain conductance) that is a derivative of a drain current, or GMBS (transconductance) that is a derivative with respect to a substrate bias.

### Second Embodiment

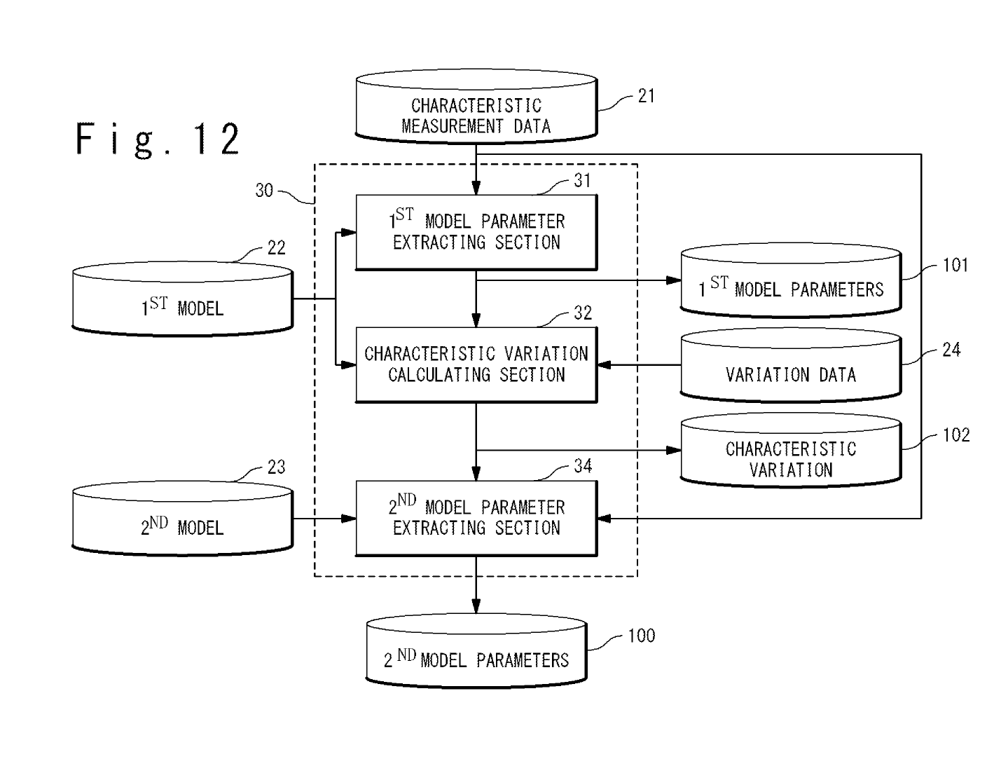

Referring to FIG. 12, the designing supporting system 10 according to a second embodiment of the present invention will be described. In the first embodiment, the system and method that evaluates the error between the simulation result by using the prepared second model 23 and the characteristic measurement data 21 will be described. In the second embodiment, the evaluation result is used to describe a system and method that extract adequate parameters that can be used for circuit analysis.

In the following description, a configuration and operation different from those in the first embodiment will be described. FIG. 12 is a functional block diagram of the designing supporting system 10 according to the second embodiment of the present invention. Referring to FIG. 12, a design supporting program 30 in the second embodiment realizes a function (analysis part) of a second model parameter extracting section 34 in place of the characteristic error evaluating section 33 in the first embodiment. A configuration and operation other than those described are the same as those in the first embodiment. That is, even in the designing supporting system 10 in the second embodiment, the first model parameters 101 are extracted and the characteristic variation 102 is calculated in the same manner as that in the first embodiment.

The second model parameter extracting section 34 performs fitting processing between the characteristic measurement data 21 and the simulation result based on the second model 23 to extract the optimum model parameters (hereinafter to be referred to as the second model parameters 100). The second model parameter extracting section 34 uses the second model 23, and varies the model parameters to extract the second model parameters 100 according to algorithm exemplified by a least square method, Newton method, Marquardt method, or the like. At this time, the error evaluated in the fitting processing have been normalized based on the characteristic variation 102 in the same manner as that of the characteristic error evaluating section 33 in the first embodiment.

Specifically, the second model parameter extracting section 34 continues to perform the fitting processing until the mean error total_error shown by the above equations (17) and (18) and normalized based on the characteristic variation 102 is minimized, and extracts the model parameters obtained when the mean error total_error is minimized, as the second model parameters 100. The extracted second model parameters 100 are recorded in the storage unit 10 in relation to the corresponding second model 23.

The second model parameters 100 extracted by the second model parameter extracting section 34 include data on manufacturing condition, dimensions, and operation condition of a device, e.g., transistor, and other data. For example, the data on the manufacturing condition of the transistor is data on manufacturing conditions such as ion implantation condition, and diffusion condition of a gate electrode, a gate oxide film, and diffusion layer (source region/drain region). As the data on the manufacturing conditions, a carrier mobility μ, a channel impurity concentration Nsub, and a flat band voltage Vfb are exemplified. Also, as the data on the dimensions of the transistor, a gate length L, a gate width W, and an oxide film thickness Tox are exemplified. Further, as the data on the operation condition (bias condition) of the transistor, a substrate voltage Vb, a gate voltage Vg, a drain voltage Vd, a source voltage Vs, and an operation temperature T are exemplifies.

As described above, in the designing supporting system 10 in the present embodiment, the error normalized based on the characteristic variation obtained through the simulation using the first model having high prediction accuracy is used to extract the model parameters. In the present invention, the error used in the fitting processing is normalized based on the same reference in a range from the off-condition to on-condition of the transistor. For this reason, the model parameters can be extracted without the error evaluation being biased depending on the bias condition. Therefore, according to the present invention, the highly accurate model parameters can be extracted independently of the bias condition.

Also, the mean error total_error shown by the above equation (17) represents the error value with respect to the characteristic variation due to a process variation. For example, when the mean error total_error is 10%, it means that even under any bias condition i, the error between a result of the simulation by using the second model 23 and the characteristic measurement data 21 is 10% with respect to a characteristic variation due to the process variation. This case represents that an extraction error of the second model parameters 100 are 10% with respect to the characteristic variation range due to the process variation. That is, by using the second model parameters extracted by the model parameters extracting method according to the present invention, circuit analysis or circuit design can be performed, taking a parameter extraction error into consideration.

### Third Embodiment

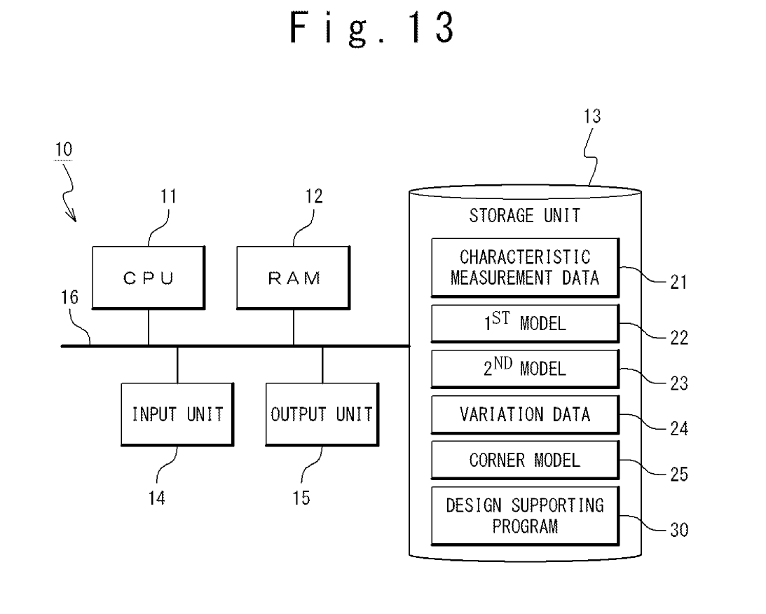

Referring to FIGS. 13 to 15, the designing supporting system 10 according to a third embodiment of the present invention will be described. In the first embodiment, the system and method that evaluate the error between the simulation result by using the prepared second model 23 and the characteristic measurement data 21 have been described. In the third embodiment, a system and method that perform a margin design using the evaluation result will be described.

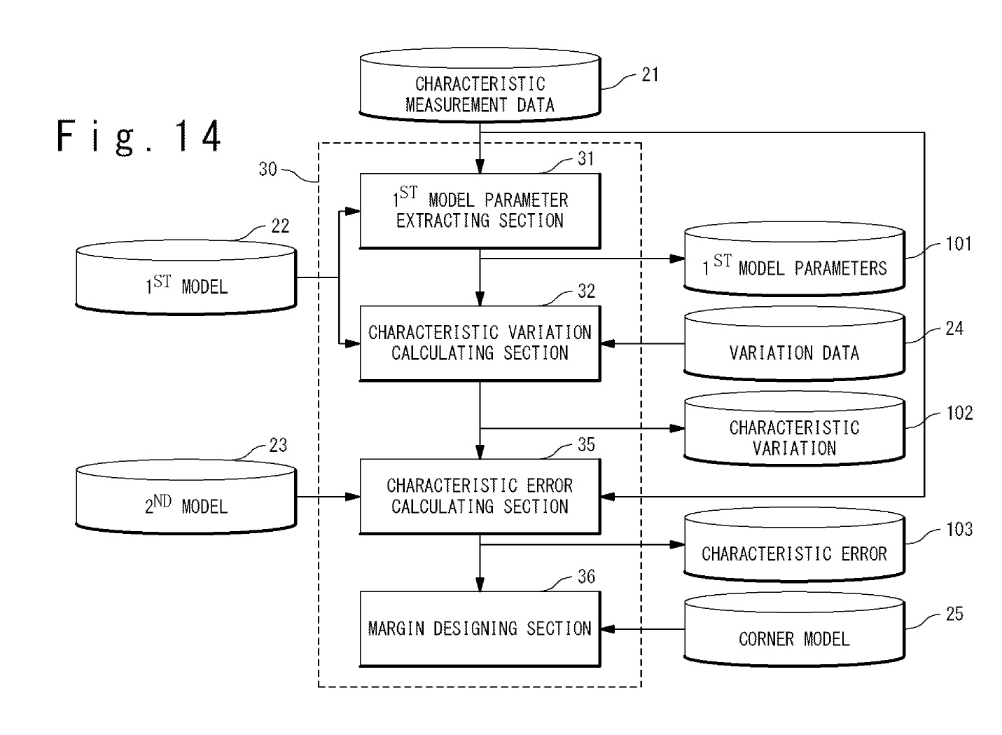

In the following description, a configuration and operation different from those in the first embodiment will be described. FIG. 13 is a diagram illustrating a configuration of the designing supporting system 10 according to the third embodiment of the present invention. FIG. 14 is a functional block diagram of the designing supporting system 10 according to the third embodiment of the present invention. Referring to FIGS. 13 and 14, in a storage unit 13 in the third embodiment, a corner model 25 is stored, and the design supporting program 30 realizes functions of a characteristic error calculating section 35 and margin design section 36 (analyzing section) in place of the characteristic variation evaluating section 33 in the first embodiment. The configuration and operation other than them are the same as those in the first embodiment. That is, even in the designing supporting system 10 in the third embodiment, the first model parameters 101 are extracted and the characteristic variation 102 is calculated in the same manner as that of the first embodiment. It should be noted that it is assumed that, appropriate model parameters that can be used for circuit analysis or circuit design are set for the second model 23.

The characteristic error calculating section 35 calculates the error between the device characteristic calculation data by using the second model 23 and the characteristic measurement data 21 to output a characteristic error 103 obtained by normalizing the error based on the characteristic variation 102.

Specifically, as shown by the above equation (16), the characteristic error calculating section 35 calculates as the error error(i) under each bias condition i, values obtained by dividing differences between a log value of the characteristic calculation data (in this case, drain currents I_{d,sim2}(i)) using the second model 23 (sim2) and a log value of the characteristic measurement data 21 based on the characteristic variation 102 Id(i).

Also, the characteristic error calculating section 35 may use a square mean of the error error(i) under each bias condition i as the mean error total_error to evaluate a model. In this case, the mean error total_error is shown by the above equations (17) and (18). The characteristic error calculating section 35 outputs the mean error total_error to the margin design section 36 as the characteristic error 103.

The margin design section 36 uses the corner model 25 and the characteristic error 103 to perform the margin design for a semiconductor device (e.g., MOSFET).

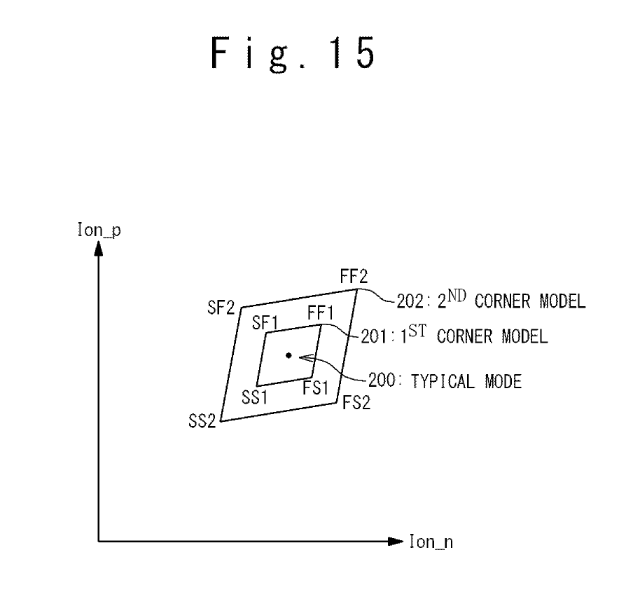

Referring to FIG. 15, details of a margin design method according to the present invention will be described. FIG. 15 is a diagram illustrating an example of the margin design using a model that is extracted by the model extracting method according to the present invention. In FIG. 15, an on-current Ion_p of a P-channel MOS transistor and an on-current Ion_n of an N-channel MOS transistor in a CMOS are respectively allocated to Y and X axes, and a current value (FAST) having the smallest delay amount and a current value (SLOW) having the largest delay value are respectively denoted by F and S. The corner model is represented by combinations of F and S, each of which corresponds to the on-current Ion_p or Ion_n, i.e., represented by a region surrounded by lines connecting FF, FS, SS, and SF. It should be noted that the corner model illustrated in FIG. 15 is represented by the on currents of the transistors, but may be represented by other parameters (threshold voltages of the transistors).

The margin design section 36 first sets a model extracted based on the characteristic measurement data 21 to be a typical model 200. Then, the margin design section 36 generates or extracts a first corner model 201 from the corner model 25, taking into consideration the characteristic variation due to a process variation with respect to the typical model 200. In this case, the first corner model 201 surrounded by corners FF1, FS1, SS1, and SF1 is generated. Subsequently, the margin design section 36 expands (or shrinks) the corners FF1, FS1, SS1, and SF1 of the first corner model 201 to a size corresponding to the characteristic error 103 (mean error total_error) to generate a second corner model 202. Thus, in each of corners FF2, FS2, SS2, and SF2 of the second corner model 202, the characteristic variation due to the process variation and an error with respect to the characteristic variation due to the process variation are added to the typical model 200. The second corner model 202 is stored in the storage unit 13 as the corner model 25 used for the margin design.

That is, the on-currents (Ion_n and Ion_p) in the second corner model 202 have values in which the characteristic error 103 (the error to the characteristic variation due to the process variation) to the on-currents in the first corner model 201 is added to the on-currents in the first corner model 201. For example, when the characteristic error 103 (mean error total_error) is 10%, and the on-current (Ion_n and Ion_p) in the first corner model 201 are ±300 of the on-current in the typical model 200, the on-current in the second corner model 202 become ±33% of the on-current in the typical model 200.

Alternatively, when the characteristic error 103 (mean error total_error) is 10%, and the threshold voltage Vth in the first corner model 201 is ±50 mV with respect to that of the typical model 200, the threshold voltage Vth in the second corner model 202 becomes ±55 mV with respect to that of the typical model 200.

Further, when the characteristic error 103 (mean error total_error) is 10%, and a current value under the off-condition in the first corner model 201 is exp(±3)=0.05 times/20 times with respect to that of in the typical model 200, the current value under the off-condition in the second corner model 202 becomes exp(±3.3)=0.037 times/27 times with respect to that in the typical model 200.

In a case of combining the second and third embodiments, the mean error total_error at the time of extracting the second model parameters 100 is used as the characteristic error 103. In this case, the second corner model 202 serves as a model added with the characteristic variation due to the process variation and an extraction error of the second model parameters 100 to the typical model 200. That is, in the present invention, the margin design for the process variation can be performed, taking into account the model parameter extraction error.

In the above, the embodiments of the present invention have been described in detail. However, a specific configuration is not limited to configurations in the above embodiments, but any modification without departing from the scope of the present invention is included in the present invention. The designing supporting system 10, and analysis/design methods in the first to third embodiments can be combined within a technically feasible range. In the above-described embodiments, as an electronic device, the MOSFET is taken as an example to provide the description. However, a diode, a schottky barrier diode MOSFET, a transistor, a junction FET, a-Si TFT (Thin Film Transistor), poly-Si TFT, a bipolar transistor, or the like can be applied in the same manner.

Also, in the above-described embodiments, the error evaluation in the drain current-gate voltage characteristic and the model parameters extracting method using the result of the evaluation have been described. However, without limitation to this, model error evaluation in a gate leakage current characteristic, a gate capacitance characteristic, a substrate current characteristic, or a noise characteristic, and the model parameter extraction and margin design using a result of the evaluation may be performed. It should be noted that, preferably, the present invention is applied to the drain current characteristic or the noise characteristic that are varied depending on the bias condition. Also, it should be appreciated that, in a case of performing evaluation and parameter extraction in electrical characteristic other than the drain current characteristic, as the first model 22 used to calculate the characteristic variation 102, a model having high prediction accuracy of a characteristic variation is selected.

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A semiconductor circuit designing supporting method, executed by a computer, comprising:
storing two models of a first model and a second model in a storage unit as a device model of a semiconductor device;
calculating a variation of a device characteristic when process parameters are varied, by using said first model;
normalizing an error between device characteristic data calculated by using said second model and actual measurement data, based on said device characteristic variation; and
analyzing said second model by using the normalized error.

2. The semiconductor circuit designing supporting method according to claim 1, wherein said analyzing comprises:
evaluating said normalized error.

3. The semiconductor circuit designing supporting method according to claim 1, wherein said analyzing comprises:
extracting model parameters of said second model when an average of values of said normalized error is minimized, to store in said storage unit.

4. The semiconductor circuit designing supporting method according to claim 1, wherein said analyzing comprises:
generating a first corner model by adding said device characteristic variation due to a process variation to said corner model generated based on said actual measurement data; and
extending or reducing said first corner model based on said normalized error, to generate a second corner model.

5. The semiconductor circuit designing supporting method according to claim 1, wherein said calculating a variation comprises:
calculating a first device characteristic by using said first model;
calculating, by using said first model in which any of the model parameters are varied, at least one second device characteristic corresponding to the varied model parameters; and
calculating as said device characteristic variation, a root mean square of errors, each of which is an error between a log value of said first device characteristic and a log value of said second device characteristic.

6. The semiconductor circuit designing supporting method according to claim 1, wherein said normalizing comprises:
calculating an error for every device condition by dividing an error between a log value of said device characteristic calculated by using said second model and a log value of said actual measurement data by said device characteristic variation for every device condition; and
outputting a root mean square of the errors for the device conditions as an average of said normalized errors.

7. The semiconductor circuit designing supporting method according to claim 1, wherein said calculating a variation of a device characteristic comprises:
varying any of a gate length, a gate width, an oxide film thickness, and a channel impurity concentration of a transistor as said process parameters.

8. The semiconductor circuit designing supporting method according to claim 1, wherein said first model is a model in which prediction precision of the characteristic change is coincident with said actual measurement data within a predetermined range.

9. The semiconductor circuit designing supporting method according to claim 1, further comprising:
extracting first model parameters by varying predetermined process parameters of said first model under predetermined bias condition,
wherein said calculating a variation comprises:
calculating said device characteristic variation by varying a part of said first model parameters.

10. The semiconductor circuit designing supporting method according to claim 1, wherein said device characteristic is a gate voltage-drain current characteristic in a transistor.

11. A semiconductor circuit designing supporting system, comprising:
a storage unit in which two models of a first model and a second model are stored as device models a semiconductor device; and
an operation unit,
wherein said operating unit comprises:
a characteristic variation calculating section configured to calculate a variation of a device characteristic when process parameters are varied by using said first model; and
an analyzing section configured to normalize based on said variation, an error between a device characteristic calculated by using said second model and actual measurement data and to analyze said second model by using the normalized error.

12. The semiconductor circuit designing supporting system according to claim 11, wherein said analyzing section comprises:
a characteristic error evaluating section configured to evaluate said normalized error.

13. The semiconductor circuit designing supporting system according to claim 11, wherein said analyzing section comprises:
a model parameter extracting section configured to extract model parameters of said second model when an average of said normalized errors is minimized to store in a storage unit.

14. The semiconductor circuit designing supporting system according to claim 11, wherein said analyzing section comprises:
a margin design section configured to generate a first corner model obtained by adding said variation due to a process variation to a corner model generated based on the actual measurement data, and extend and reduce said first corner model based on said normalized error, to generate a second corner model.

15. The semiconductor circuit designing supporting system according to claim from 11, wherein said characteristic change calculating section calculates a first device characteristic by using said first model, calculates by using said first model in which any of the model parameters are varied, at least one second device characteristic corresponding to the varied model parameters, and calculates as said device characteristic variation, a root mean square of errors, each of which is an error between a log value of said first device characteristic and a log value of said second device characteristic.

16. The semiconductor circuit designing supporting system according to claim 11, wherein said analyzing section calculates an error for every device condition by dividing an error between a log value of said device characteristic calculated by using said second model and a log value of said actual measurement data by said device characteristic variation for every device condition, and outputs a root mean square of the errors for the device conditions as an average of said normalized errors.

17. The semiconductor circuit designing supporting system according to claim 11, wherein said characteristic variation calculating section varies any of a gate length, a gate width, an oxide film thickness, and a channel impurity concentration of a transistor as said process parameters.

18. The semiconductor circuit designing supporting system according to claim 11, wherein said first model is a model in which prediction precision of the characteristic change is coincident with said actual measurement data within a predetermined range.

19. The semiconductor circuit designing supporting system according to claim 11, further comprising:
a parameter extracting section configured to extract a first model parameter by varying a predetermined process parameter of said first model under predetermined bias condition,
wherein said analyzing section calculates said device characteristic variation by varying a part of said first model parameters.

20. The semiconductor circuit designing supporting system according to claim 11, wherein said device characteristic is a gate voltage-drain current characteristic in a transistor.

21. A non-transitory computer-readable recording medium storing program code, executed by a computer, to attain a semiconductor circuit designing supporting method, wherein said semiconductor circuit designing supporting method comprises:
storing two models of a first model and a second model in a storage unit as a device model of a semiconductor device;
calculating a variation of a device characteristic when a process parameter is varied, using said first model;
normalizing an error between device characteristic data calculated by using said second model and actual measurement data based on said device characteristic variation; and
analyzing said second model by using the normalized error.
